(19) United States
(12) Patent Application Publication
(10) Pub. No.: US 2017/0321852 A1
(43) Pub. Date: Nov. 9, 2017

(54) MODULAR LUMINAIRE AND METHOD OF MANUFACTURE

(71) Applicant: Innovative Lighting, LLC, Roland, IA (US)

(72) Inventors: Jerrold Handsaker, Roland, IA (US); Harry Aller, Indianola, IA (US); A. Brent York, Fort Langley (CA)

(21) Appl. No.: 15/496,760

(22) Filed: Apr. 25, 2017

Related U.S. Application Data
(60) Provisional application No. 62/327,164, filed on Apr. 25, 2016.

(51) Int. Cl. F21S 8/02; F21V 23/00; F21V 29/70; F21S 9/02; F21V 5/04; F21V 23/06; F21V 15/01; F21Y 2115/10; F21Y 2103/10

(52) U.S. Cl. CPC F21S 8/026; F21V 23/06; F21V 23/003; F21V 23/001; F21V 15/01; F21V 29/70; F21S 9/022; F21V 5/04; F21Y 2103/10; F21Y 2115/10

(57) ABSTRACT

A luminaire includes a housing with a single piece, monolithic body, and a circuit board coupled to the housing. The circuit board includes circuitry for connection of lighting elements thereto, and is connectable to an external controller. An external controller controls lighting functions of the luminaire over a low voltage power and data connection.

### RELATED APPLICATIONS

The present application is based on and claims the benefit of U.S. provisional patent application Ser. No. 62/327,164, filed Apr. 25, 2016. A related disclosure entitled POE CONTROLLED LIGHT FIXTURES WITH INCORPORATED POE CONTROLLED VARIABLE CONDITIONED AIR VENTS and filed on even date herewith discloses further integration of this disclosure into building HVAC systems with passive and active delivery mechanisms for airflow and other non-lighting functions.

### BACKGROUND

Conventional lighting fixtures for the last century have largely been manufactured in factories employing raw materials such as steel, aluminum and plastic with lighting components such as light bulbs, sockets, ballasts and wire. The processes used have coined the term “metal benders” as a colloquial expression to describe the conventional processes employed by traditional lighting manufacturers. Conventional fixtures are largely made from sheet goods, extrusions and other raw materials that are heavily processed in factory with die cutting, punching, forming and other mechanical processes. During the last decade, with the rapid decline in price and rapid increase in performance, the Light Emitting Diode or ‘LED’ has reached the point where its performance exceeds all conventional light sources and its cost now rivals conventional light sources, especially where the total cost of ownership over the life of the lighting installation is considered. The properties of LEDs, combined with the miniaturization of electronics of all types have created a unique environment for new devices in the ceiling area of buildings that can provide for illumination and other useful functions.

### SUMMARY

The present disclosure is related to novel luminaire designs that significantly reduce the component count and bill of materials required for illumination devices that can also support additional functions beyond lighting. Embodiments of the disclosure are environmentally significant since it has excellent cradle to cradle properties for recycling and re-use while minimizing the entire environmental footprint for lighting, sensing, power and control systems in modern buildings.

The present disclosure is in the technical field of lighting fixtures or lighting nodes as will be described in more detail within the specification herein.

The present disclosure is directed to various lighting node structures that typically reside within the ceiling area of a space that simplify an environmental footprint for the provision of lighting and other functions. Since traditional light sources either require high voltages or operated at very high temperatures it was historically imperative to manufacture lighting fixtures with materials that could provide adequate protections from both of these hazards. As noted, LEDs and other semiconductor sources of light such as laser diodes, quantum dot matrixes, carbon nanotube emitters, and organic light emitting polymers and other semiconductor types of light sources usually operate at safe low voltages (<60 V) and at fairly low temperatures (typically <100 Celsius) Therefore they can be used in proximity to materials that are not commonly capable of operation with traditional light sources.

The present disclosure provides a structure that is able to render the functionality of a light fixture, or luminaire, in an assembly of minimal material at a minimal manufacturing footprint. In addition, the assembly of all parts can be achieved via translation of the constituent parts in only one axis which makes assembly even more achievable via automated means, or highly efficient manual means. This mode of assembly is highly desirable as it reduces the manufacturing overheads commonly associated with assembly complexity that either drives up machine or human time and adds cost to the final fixture.

The embodiments of the disclosure are capable of rapid assembly with low cost. The overall cost of assembly in the overall cost Bill of Materials (BOM) is reduced to a point where the economic cost of manufacturing is reduced. In manufacturing of embodiments of the present disclosure, relative country labor rates are potentially eclipsed by transportation costs, which renders the traditional manufacturing advantages of particular countries moot. Thus, the embodiments of the disclosure are significant in that it enables fixtures to be made close to their end use markets and thus reduce the amount of energy and fuel needed to transport materials thereby benefitting the environment. The embodiments of the disclosure also consolidate various functions into a highly adaptable ceiling node that can be enabled with various functions beyond lighting. Other embodiments of the disclosure support, for example, emergency lighting needs, egress needs, spatial sensing, data transmission, and user customized needs such as special optical patterns and lighting functions that can be changed as the needs and tasks within the space are adapted over time. Further advantages of the disclosure include embodiments of the luminaire with as few as two or three parts which are readily assembled and separated. This simplicity of components and like materials also ensures that the end of life or service cycle for the luminaire can be readily recycled or upcycled in time with a minimal flow of materials into the waste stream. Users of the embodiments are able to economically and conveniently rebuild, or customize, their lighting and ceiling functions over time.

In one embodiment, a luminaire includes a housing of monolithic injection molded construction, and a circuit board coupled to the housing, the circuit board including circuitry for connection of lighting elements thereto, and connectable to an external controller.

In another embodiment, a modular luminaire includes an injection molded body, of monolithic construction, that fills a planar projection in first and second orthogonal axes, and a planar circuit board assembly having a plurality of light emitting elements. The planar circuit board is coupled to the injection molded body along a third axis orthogonal to the each of the first and the second axes.

In another embodiment, a method of assembling a luminaire includes providing a housing of monolithic injection molded construction, providing a circuit board including circuitry for connection of lighting elements thereto, and coupling the housing to the circuit board, wherein coupling is accomplished by translation of the housing and circuit board relative to each other on a single axis.

In yet another embodiment, method of manufacturing a luminaire includes forming a seamless housing having at least one opening for connection of a lighting element, coupling a lighting element on a circuit board to the housing, coupling the circuit board to an external controller.

Aspects of the disclosure include those discussed below under the heading aspects of the disclosure/claims, although the disclosure is not so limited, and additional functions and uses, improvements, refinements, and the like are within the scope of those skilled in the art, and are therefore contemplated by the disclosure.

### BRIEF DESCRIPTION OF THE DRAWINGS

FIG. 1a is an exploded view of a conventional recessed circular “can” fixture.

FIG. 1b is an exploded view of a conventional recessed “troffer” fixture.

FIG. 2 is a schematic of one embodiment of the disclosure.

FIG. 3 is a reference coordinate system for the disclosure.

FIG. 4 is a schematic detail of the disclosure with external connection provision.

FIG. 5 is a schematic of another embodiment of the disclosure with a plurality of external connections enabling sensors or other devices.

FIG. 6a is a schematic of another embodiment of the disclosure with a provision for an emergency battery back-up and switching apparatus.

FIG. 6b is an exemplary control circuit according to an embodiment of the present disclosure.

FIG. 7a is a schematic of an embodiment of the disclosure with provision for environmental accessories.

FIG. 7b is an example of a detail in the housing that permits optional accessories to be added.

FIG. 8 is a schematic of another embodiment of the disclosure with only two parts.

FIG. 9 is a schematic of another embodiment of the disclosure that permits customized optical patterns.

FIG. 10 is a block diagram of a computer on which embodiments of the present disclosure may be practiced.

### DETAILED DESCRIPTION

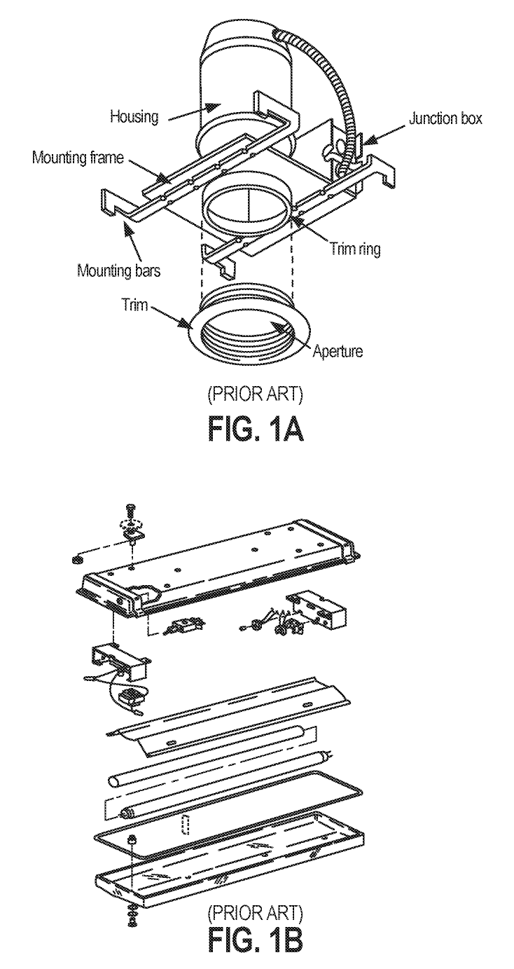

Traditional lighting fixtures for use in the ceiling plenum of offices and commercial spaces are largely dominated by structures such as those shown in FIG. 1a and FIG. 1b which are essentially boxes and cans that encircle a traditional round light bulb or reflector type light bulb or elongated cylindrical light bulb such as a fluorescent tube. As FIG. 1a shows, there are many parts, primarily made of metal, that are created via shearing, stamping, bending, spinning, welding and other highly mechanized processes that convert sheet metals into light fixture housings. Some plastic parts may be present in the trim materials where the high bulb temperatures are not present and these are commonly manufactured in an injection molding process with perhaps some finishing processes such as painting. FIG. 1b is a traditional fluorescent “troffer” which typically consist of a sheet metal box having various reflective sheets and cowlings inserted within them to deflect light, cover wiring compartments, and to hold sockets. A molded lens, formed metal deflector or assembly of highly reflective and bent structures are also provided on the bottom that are used to modify the light emission from the fluorescent tubes and distribute light within the space. Common features of prior art luminaires using conventional bulbs is that they require the use of wires and electrical code dictated wiring boxes or enclosures to complete their wiring to the primary mains power in the building. During manufacturing of these luminaires in the factory, the components are screwed, riveted, welded or formed together with sub-components such as sockets, ballasts and other components where wire is routed within the fixture to the various points of electrical connection to complete the lighting circuit.

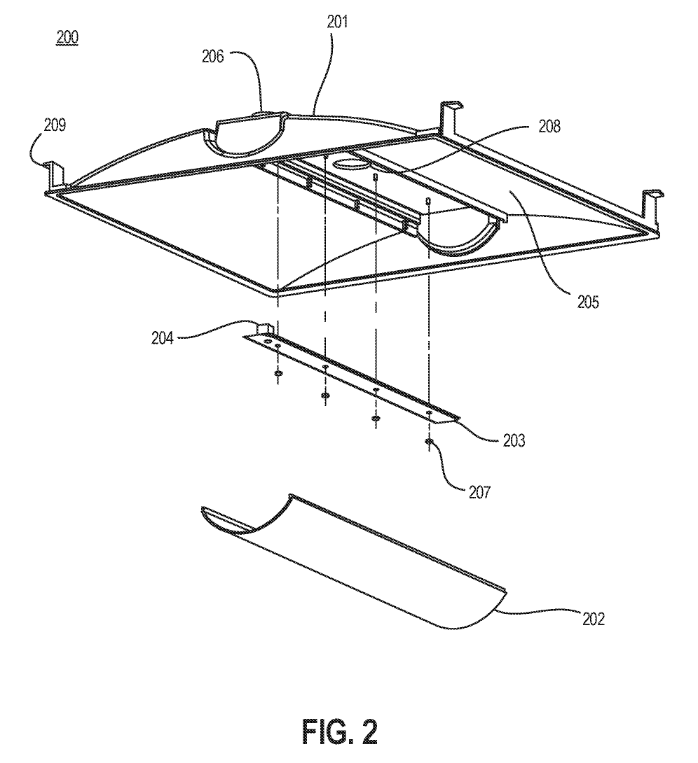

FIG. 2 is an exploded view of one embodiment of a modular luminaire 200 or alternatively, a ceiling service node that can provide area lighting but also serve as a data/power and services hub that can support a plurality of sensors, transducers, emitters and devices that could be optionally incorporated within the housing and electrical framework within 200. Unlike prior art lighting fixtures this luminaire 200 also eliminates the need for all internal wiring. Prior art luminaires typically require the stringing of wires through the structure. With the single piece monolithic construction of the luminaire embodiments of the present disclosure, the circuit boards and the power to those circuit boards are connected directly, such as with the plug system as described further below. Furthermore, luminaire embodiments according to the present disclosure comprise as little as two primary parts with an optional third part for the modification of the light pattern. Yet another improvement in the art is that this luminaire 200 is able to be assembled in seconds instead of minutes by having the primary constituent parts join together through a simple translation of the parts in one axis making it particularly advantageous for automated methods of manufacturing.

Modular luminaire 200 comprises in one embodiment a single monolithic unibody housing 201 that is formed in a single injection molding cycle with all of the critical details, surfaces and other attributes created in a single step. In contrast to previous luminaires which often require sheet metal to be stamped, formed, welded and riveted together from a variety of smaller parts before they are ready for paint preparation, undercoating and final painting. After this step, conventional luminaires then require wires to be stretched within the housing, reflective sheets to be inserted, sockets to be mounted and ballasts to be attached. Once the ballasts are attached they are then usually covered or housed within some form of enclosed space within the luminaire with wires running to some form of junction box. Often many wire nuts and electrical connectors are manually used to join the circuits together and then finally a lens may be added to the front of the luminaire to modify the light.

After assembly of all of these components it is customary to then quality check, label, bag, and package with accessory parts that may be needed for installation. The usual timeframe for assembly in the industry is often in excess of 15 minutes per luminaire, with some fixtures approaching an hour of labor from the handling of raw material at the dock to a boxed fixture on a pallet ready to be loaded. As can be appreciated, this assembly time and the many handling and assembly steps that are needed for assembly of traditional luminaires are costly in high labor rate jurisdictions, which is why most prior art lighting fixtures are often built overseas as the cost of shipment is usually offset by the very high differential between domestic labor and foreign labor cost components in the final bill of materials (BOM). With the advent of high performance LEDs used in lighting the manufacturing processes for lighting fixtures has remained largely unchanged in this very traditional lighting industry. The sheet metal processes are virtually the same and the only real change is that an LED array is inserted into the housing system in place of the traditional light bulb found in similar shaped luminaires. Attendance at major industry trade shows during the last few years demonstrates this fact as almost every fixture type imaginable is now designed with LEDs inside and yet exterior visual appearance and the relative structure of the luminaire remains consistent with a time when reflector bulbs, linear bulbs and round bulbs were the dominant light sources.

Embodiments of the disclosure reduce the complexity of the fixture manufacturing and assembly process by reducing it down to what is essentially two parts with an optional optical assembly. Referring to FIG. 2, the monolithic unibody housing 201 replaces several parts and steps that would be found in a traditional sheet metal luminaire. In this embodiment the usual box with several metal parts pre-formed and riveted or welded together are created in one injection molding process. Instead of having to paint a reflector surface or insert a shaped reflective material into the fixture this embodiment instead relies on the inherent properties of high white reflectance found in certain plastic resin products to create the reflector surface 205. By modifying the mold profile and surface treatment in the injection mold tool it is also possible to create a wide variety of reflective responses and balanced levels of specular versus diffuse reflectance from the surfaces such as 205 within the luminaire 200. This improvement dramatically reduces the several steps traditionally needed for shearing, punching, forming, joining, texturing, cleaning and painting the surfaces of traditional luminaires to perform the same function.

The second major component of this embodiment of the modular luminaire 200 is the circuit board 203. This circuit board 203 can be a standard glass filled epoxy printed circuit board, a flexible printed circuit board, a metal core printed circuit board or any other method of creating a circuit layout that can have light emitting diodes or other electronic light sources put into electrical communication with each other and any other electronic components that may be used to regulate current, provide processing, store data or otherwise increase the functionality of the modular luminaire 200. The circuit board 203 is designed to be mechanically attached to the housing 201 via mechanical alignment with mating components molded into the housing. Fastening washers 207 are optionally shown and could be used to ensure that the circuit board remains joined to the housing 201.

Alternative methods of joining may be used, such as but not limited to adhesive, sonic welding, friction fit, snap fit or any other mechanical bonding technique that will effect a join between the board and the housing. Electrical socket 204 on the circuit board 203 is shown on the reverse side of the circuit board 203 with pass through traces to the upper surface of the board 203. It is designed to align to a cut-out on the back of the housing 201 at the location 206. This socket 204 is designed to align to this raised cut-out and permit the insertion of a mating connector (not shown) attached to a cable (not shown) that comes in from the rear and is pushed down through the opening until it connects with the socket 204 thereby providing a circuit connection to an external power source, a data source, a controller, or a combination of any of these.

Preferably this connector and cable are of the Ethernet type category cable (e.g., CAT 5, CAT 5e, CAT6), or equivalent multi-conductor cable, as it conveniently can provide provision for both power and data within a unified connector and cable assembly. A Power over Ethernet (POE) switch may be used as a driver for the circuit board and lights thereon. Alternatively, intermediate elements such as a lighting controller, wall switches, sensors, and the like, may be employed between the luminaire and its ultimate power supply.

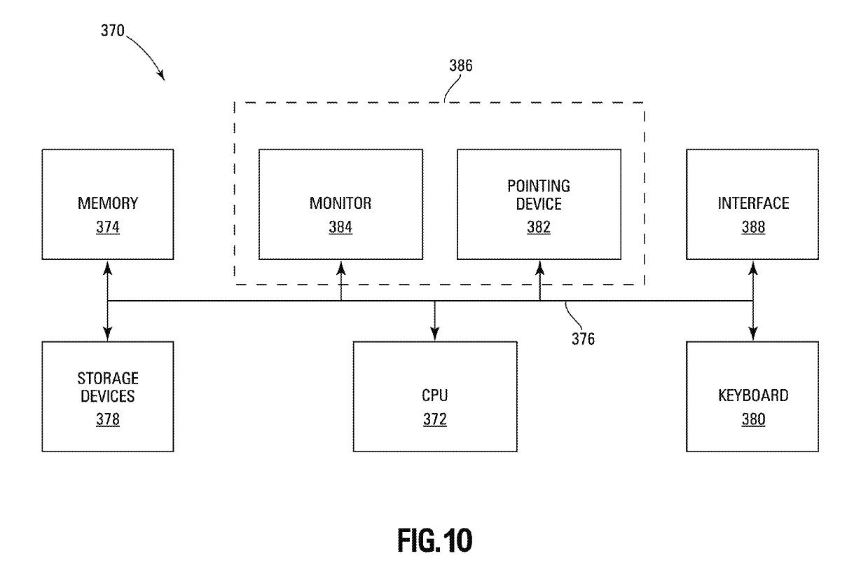

In one embodiment, the circuit board provides only electrical connections allowing for operation of the attached lighting elements. Control of the lighting elements, such as their functionality, is controlled with an external controller 100 such as is shown in block form in FIG. 4. Controller 100 may be coupled also to wall switches, sensors, and the like, and may be in one embodiment provided with data and power through the POE switch. POE switch is in turn coupled for communication with a computer (see FIG. 10) to allow for control of operations for the system.

A further consideration is that the cut-out 206 and the socket 204 may exist in more than one location on the back of the luminaire housing 201 and the circuit board 203. This provision for extra cut-out and connection locations can provide for additional functional components such as occupancy sensors, emergency beacons, cameras, speakers or transducers/exciters (e.g., a magnet on the back of a speaker adhered by tape or other connection to a back of a luminaire to turn the luminaire into a device that can emit sound or voice signals such as an intercom system, emergency alarm system, or the like), antennae, light based communications emitters, ambient light sensors or any other functional component that may be advantageously placed in the vicinity of the luminaire ceiling node. These functional components can be designed to fit matching punch out locations in the housing 201 such as shown in location 208. As an example, location 208 can be designed to be easily removed in the field such that a functional component can be snapped into the housing 201. By having these punch out locations placed in different locations it is possible to equip the housing 201 with a wide variety of functional components that can be used as options to make the lighting fixture far more useful than just for the production of light.

In one embodiment, a common electrical system may be used to unite both the lighting functions provided for on board 203, with the functional components which may be added at various locations on the housing 201. In general, most components, unless they are energy harvesting types, must have a source of power at minimum to perform some function. More advanced components may be designed to use both power and require data input and/or data output to add value. An example of the latter functional component could be an occupancy sensor that relies on power to activate the sensor array that will be triggered by changes in the infrared environment in its field of view. After being triggered it then requires a data line to communicate this information to a circuit that can act on this information and determine if the light sources need to have their output state changed. A convenient means to connecting all of these optional functional components is via a low voltage cable that can provide for both power and data such as a category cable and connector. Low voltage cable is connectable to a controller or control system (described below), which may be an external controller, or may be part of a system including a luminaire and the controller.

Luminaire ceiling node 200 can directly benefit from this Ethernet type cable and connector system because it is possible to equip the optional functional components with sockets and logic circuits that have an electronic address and can provide i/o functions such that the data they obtain from the environment can be sent back through their connected cables to a processor, or a remote network, for analysis. This information can then be processed and potentially further actions may be communicated via the parallel power lines that run within the category cables back to other components in the system.

Luminaire 200 may also include optional element 202 which can provide a degree of optical shaping or homogenization of the light from a potential plurality of electronic light sources that are located on one or more planes of circuit board 203. The optical element 202 is designed in one embodiment to snap directly into the housing 201. Other joining methods may be employed without departing from the scope of the disclosure, including glue bonding, ultrasonic bonding, plastic welding or even other components that cause these two parts to be joined, or the like. Optical element 202 and housing 201 are also designed to permit a tight fit such that bugs and contaminants, for example, do not get into the proximity of the light emitting elements on circuit board 203 and impact the light levels or the aesthetics of the lighting product appearance.

Mounting and support bosses 209 are optional and are designed to provide a convenient mounting and support location for the luminaire 200 in certain jurisdictions where a mechanical support system may be needed for code compliance. Since the fixture 200 is significantly lighter than incumbent designs that have historically been built it is probable that these mounting support bosses are not needed in at least some designs because fixture 200 is so much lighter that the regulations will permit its direct use and support in a standard ceiling grid system. This alone provides a large savings in installation labor as the luminaire ceiling node can also be installed in seconds as it only has to have its respective category cable and connector pushed into and snapped into the back of the fixture. This will engage power and data to the fixture which means that it is now ready to be slid up and dropped into the recess in the ceiling. The improvement in installation labor and future potential for rapid re-deployment by simply moving the ceiling nodes around to suit the new floorplan or locations of workers will make this system save considerable money and time during installation, and/or repositioning.

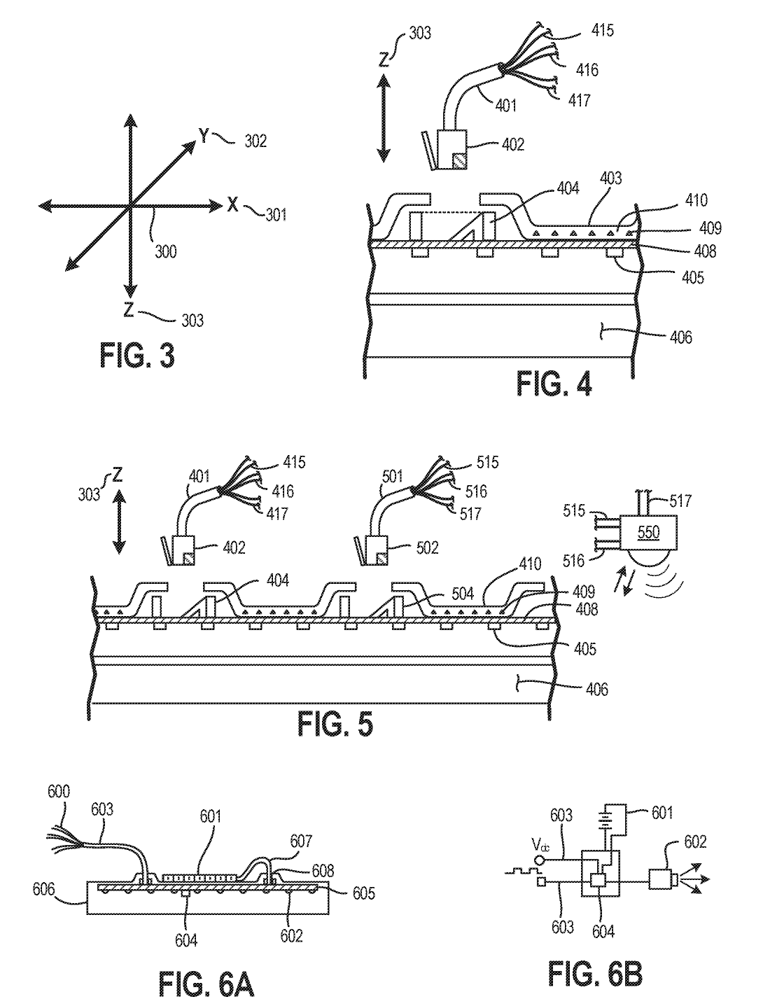

FIG. 3 is an illustration of a three axis system and is drawn in reference to spatial coordinates in 3D space. For the purposes of illustration, the x-y plane is commonly considered to be parallel to the ceiling plane above a space. The z-axis is commonly a reference to the vertical displacement from either the floor plane or the ceiling mounting plane. The ceiling node composite luminaire 200 as in FIG. 2 is designed to be mounted such that its emitting face is placed parallel to the x-y plane and the z plane is the plane by which all components are assembled into a finished luminaire. This feature of the luminaire 200 means that no parts are designed to be assembled into the luminaire with any other motion than a translation in the z axis. FIG. 2 clearly shows that the circuit board component 203 can be mated to the housing component 201 via a simple vertical z axis translation until it is in contact with the back plane of the housing. Once these two parts are assembled and it is time to install power and data to the luminaire 200, this is simply done by introducing a simple RJ45 plug and CAT5 cable assembly which simply passes through the back of the luminaire along the z-axis and plugs into the receptacle 204 that is attached to the circuit board. In this way even the installation and connections to the luminaire 200 are all done via the z-axis.

FIG. 4 illustrates one embodiment of how the circuit board 408 is positioned in proximity to the back of the luminaire housing 403. Elements 409 are shown within the material 410 that makes up the housing component 403. These elements 409 are optional but could be metal or other highly thermally conductive material such as carbon nanotubes which are designed to be placed or even oriented within the housing wall 410 to help spread heat from the back of circuit board 408 that may be produced by the light emitting electronic components 405. This material 409 could also be a metal mesh or other thermal management material that is inserted into the mold prior to molding and the resin is then shot into the tool and hardens around this material 409. This material 409 may serve to function as a thermal enhancement to the properties of the back of the luminaire. Alternatively, this material could also be used as an Electromagnetic Interference (EMI) shield to provide a block to incoming or outgoing electromagnetic energy in some wavelength range of interest. This may also be a security feature or a mechanism that reduces the chances for the drive and logic circuits to be interrupted by unintended means.

FIG. 4 further illustrates the vertical z-axis 303 coordination of the external cable 401 that carries some combination of power and data in wire pairs 415, 416 or 417. Some cables may have more and others fewer pairs of wires for the provision of data and/or power. Connector 402 is designed to slide into receptacle or socket 404 that is located on the circuit board 408 and to establish electrical connections to the circuit board 408. Element 406 is optionally a reflective side wing or lens portion that may snap or slide into the luminaire housing to act on the light to reduce glare or diffuse the light or even shape the light as would be normally undertaken in this room facing region of the ceiling node.

FIG. 5 is an expanded view of a luminaire body showing a circuit board 408 that now has two connector locations 404 and 504 that may be optionally used to provide additional functionality including the daisy chain connections of additional luminaires in a small network environment. Cables 401 and 501 each have their respective connectors 402 and 502 which can be slid into and snap into receptacles 404 and 504. Cable 401 may be used as the primary power and data line connection to the luminaire while cable 501 may be advantageously directed to element 550 which could, for example, be a remote device that can sense the occupancy within a larger space. The power to element 550 may also be provided by power over Ethernet (POE) via one of the lines 515 or 516 or 517.

FIG. 6a is a simplified schematic of a luminaire ceiling node 600 that is designed in a similar manner to the foregoing FIG. 4 but with the inclusion of a battery back-up located in proximity of the luminaire at 601. This element 601 is in one embodiment an emergency battery backup that could be a Lithium Polymer flat battery for example that is sized to provide the requisite amount of back-up power to the light sources or a subset of the light sources, as would comply with the egress and life safety standards for the luminaire to continue to illuminate the space for a length of time. Ideally this battery backup 601 is able to leverage the cable and connector at 608 that would allow the battery back-up to be added like just another functional element. However, in this case battery backup 601 is connected to circuit board 605 and provides emergency backup power in the event of a power failure that is present on the normal power and data input line 603.

FIG. 6b is an exemplary control circuit that regulates the use and charging of the battery back-up 601 via logic that is notified that power is out either directly by the network or via a low signal in the drive line 515 or other line. The regulations governing battery backup techniques can be simply achieved in this design since the required components are a source of power, a source of data and a means to store power to be kept in reserve in case there is a power outage.

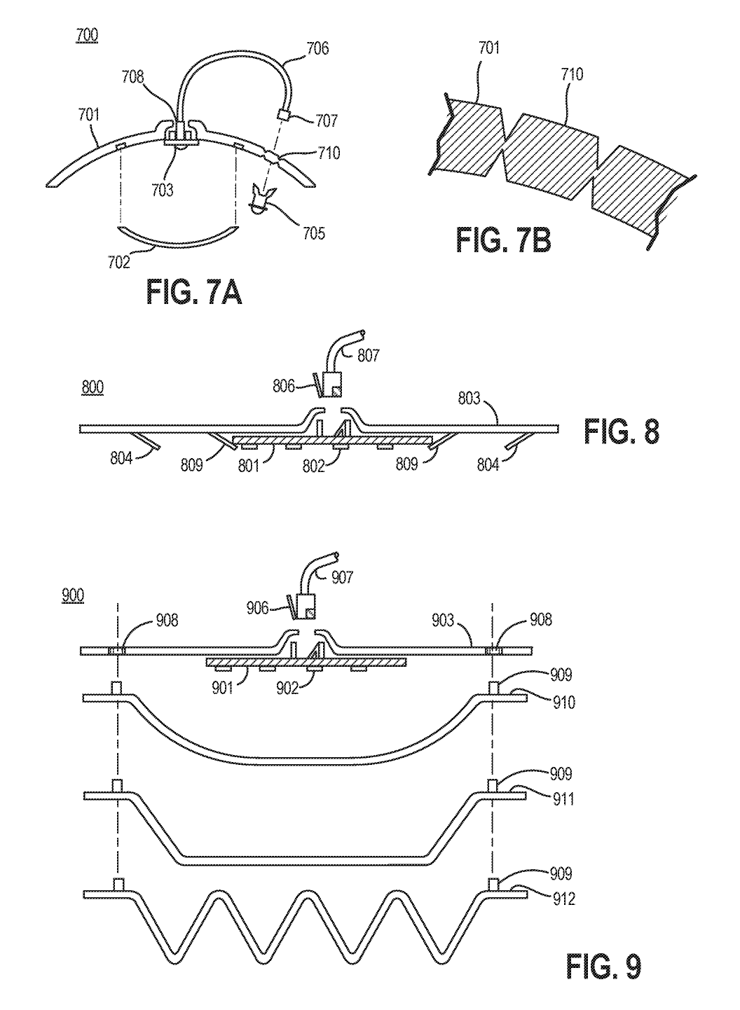

FIG. 7a illustrates how a functional component 705 could be readily adapted to the luminaire design 700 by an easily removable component within the housing of the luminaire. As shown in FIG. 7b there is a sidewall portion that shows a region 710 that by virtue of how it is molded can be readily “punched” out of the wall of the fixture providing a pass through location for the snap fitted mounting of some functional device 705. The punchout region 710 may be punched out since thinner sections 712 of the molded material allow it. This component 705 can be attached to luminaire 700 and the cable assembly 706 can come from the fixture electronic board 703 and be connected directly to device 705. FIG. 7a only shows one such device but it is readily understood that a plurality of these types of devices may be utilized for a particular luminaire design and application.

FIG. 8 is a simplified side elevation view of a two part luminaire concept where the backplane or housing for the luminaire is element 803. It is designed to be injection molded or grown via some equivalent 3D printing process. Luminaire surface 803 is designed to be produced from a single shot molding process using polymers. This illustration shows that the back-plane 803 for the circuit board 801 is designed with holding details in the mold that will catch the circuit board 801 and lock these two parts together. This luminaire design provides the raw light from the electronic light sources 802 which may be combinations of electronic light sources that can be switched on in various combinations to effect a change in the color spectral characteristics of the light. Cable connection 807 and connector 806 are designed to also translate down and connect to the circuit board 801 through a port in the back of the backplane 803.

FIG. 9 illustrates the two part concept outlined in FIG. 8 and shows how optional optical control designs such as lens elements 910, 911 and 912 can be designed separately to be built either as options for users or installers that can be used interchangeably to produce different light output patterns. These optical parts may be made available separately so a lighting installation may be installed with one pattern and years later as fashion changes a new set of parts can be purchased and installed, while reusing most of the fixture components that remain resident within the ceiling. One method of making these parts could be that they are built in small quantities for users via 3D printing at some local supplier. These optical components are also designed to be joined to the backplane 903 via bosses 909 and holes 908 that could be engaged and heat clamped, glued or make use of an alternative joining method.

Although low voltage embodiments have been described, it should be understood that traditional high voltage operations and lighting may also be controlled and housed in the luminaire embodiments of the present disclosure, without departing from the scope thereof. For example, control of the lighting operation is performed in certain embodiments from outside of the fixture. In some embodiments, the controller provides only power. Therefore, the same fixture (e.g., luminaire 200) may be coupled to an elongated cord that goes to an AC or DC power supply, and therefore may be used as an AC distribution hub with lighting.

As the luminaires of the present disclosure are manufactured in a single monolithic body, the seams that are found in traditional luminaires are not present in the luminaires of the present disclosure. Accordingly, light distribution and appearance are superior to traditional luminaires.

FIG. 10 shows a representative system that may be connected to and/or used to control embodiments of the present disclosure or a controller, such as controller 100, for those embodiments. The system 1000 described herein is usable on all the embodiments herein described, and may comprise a digital and/or analog computer. FIG. 10 and the related discussion provide a brief, general description of a suitable computing environment in which the controller 100 can be implemented. Although not required, the controller 100 can be implemented at least in part, in the general context of computer-executable instructions, such as program modules, being executed by a computer 370 which may be connected in wired or wireless fashion to the controller 100. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, or the like, allow the user to provide commands to the computer 370. A monitor 384 or other type of output device can be further connected to the system bus 376 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

Another aspect of the disclosure is that the luminaires described herein have a minimal parts count which means that it also becomes much easier for the design to be taken apart into its constituent parts either for replacement and repair or for end of life recycling where the limited number of parts makes it very easy for this separation task to be performed by automation. This valuable design can significantly reduce the time and effort needed to recycle the luminaire making it superior to conventional luminaires with their myriad of parts and mounting process. Further, the assembly process allows for assembly of the luminaires with one direction of motion. That is, all components of a luminaire according to the embodiments of the present disclosure are assembled with motion in the Z-direction along the Z-axis. This also simplifies the installation and assembly of the luminaire embodiments of the present disclosure.

Although the present disclosure has been described with reference to preferred embodiments, workers skilled in the art will recognize that changes may be made in form and detail without departing from the spirit and scope of the disclosure.

What is claimed is:

1. A luminaire, comprising:
a housing of monolithic injection molded construction; and
a circuit board coupled to the housing, the circuit board including circuitry for connection of lighting elements thereto, and connectable to an external controller.

2. The luminaire of claim 1, and further comprising a controller for control of lighting functions of the luminaire.

3. The luminaire of claim 2, wherein the controller comprises:
a low voltage power supply;
a data and power connection from the controller to the circuit board, the data and power connection coupling data and power to the circuit board.

4. The luminaire of claim 3, wherein the data and power connection is a category cable.

5. The luminaire of claim 3, wherein the data and power connection is a power over Ethernet (POE) connection.

6. The luminaire of claim 1, wherein the circuit board comprises a plug-in connector to the data cable connects to the external controller.

7. The luminaire of claim 1, wherein the housing includes a pass through, wherein the circuit board includes a connector jack, and wherein the pass through and the connector jack are aligned for connection of the circuit board to the external controller with a power connection coupleable to the connector jack.

8. The luminaire of claim 1, wherein the housing is free from interior wiring or cabling.

9. The luminaire of claim 1, and further comprising an optical element coupled to the housing or to the circuit board, to provide optical conditioning of light from lights on the circuit board.

10. The luminaire of claim 9, wherein the optical element is a lens.

11. The luminaire of claim 9, wherein the housing, the circuit board, and the optical element are connected along a single axis.

12. The luminaire of claim 1, wherein the circuit board further comprises:
an electrical socket on one side thereof, and electrical traces passing through to another side thereof, the electrical socket aligned with a cutout of the housing.

13. The luminaire of claim 1, wherein the housing and the circuit board are configured to be assembled with motion in a single axis.

14. The luminaire of claim 1, wherein the circuit board is configured to be powered by a low voltage cable.

15. The luminaire of claim 14, wherein the low voltage cable is also a data cable.

16. The luminaire of claim 14, and further comprising an external controller coupleable via the low voltage cable to the circuit board, the controller configured to control operation of the luminaire.

17. The luminaire of claim 1, wherein the housing further comprises at least one knockout configured to allow attachment of an additional element to the housing.

18. The luminaire of claim 1, wherein the housing further comprises a mesh embedded therein.

19. The luminaire of claim 18, wherein the mesh is a heat sink.

20. The luminaire of claim 1, and further comprising a battery backup coupled to the luminaire and configured to control lighting functions of the luminaire upon a power failure.

21. A modular luminaire comprising:
an injection molded body, of monolithic construction, that fills a planar projection in first and second orthogonal axes; and
a planar circuit board assembly having a plurality of light emitting elements, the planar circuit board coupled to the injection molded body along a third axis orthogonal to the each of the first and the second axes.

22. The modular luminaire of claim 21, and further comprising:
an optical member coupled to the body along the third axis.

23. The modular luminaire of claim 21, wherein the planar circuit board comprises a power/data cable socket coupleable to a power/data cable having a modular connector, the power/data cable coupleable to the planar circuit board along the third axis.

24. A method of assembling a luminaire, comprising:
providing a housing of monolithic injection molded construction;
providing a circuit board including circuitry for connection of lighting elements thereto; and
coupling the housing to the circuit board, wherein coupling is accomplished by translation of the housing and circuit board relative to each other on a single axis.

25. A method of manufacturing a luminaire, comprising:
forming a seamless housing having at least one opening for connection of a lighting element;
coupling a lighting element on a circuit board to the housing; and
coupling the circuit board to an external controller.

26. The method of claim 25, wherein forming a seamless housing comprises forming by injection molding.

27. The method of claim 25, and further comprising coupling a lens to the circuit board, the lens positioned to spatially modify a light profile from the lighting element.

28. The method of claim 25, and further comprising coupling a lens to the housing, the lens positioned to spatially modify a light profile from the lighting element.

29. The method of claim 25, wherein coupling a lighting element and coupling the circuit board are accomplished by translation of the housing, the lighting element, and circuit board relative to each other on a single axis.
